(19) United States
(12) Patent Application Publication
(10) Pub. No.: US 2006/0005456 A1
(43) Pub. Date: Jan. 12, 2006

(54) Fish scent dispenser

(76) Inventors: Darrell Harris, Oregon City, OR (US); Robert Bedient, Oregon City, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/887,659

(22) Filed: Jul. 9, 2004

(51) Int. Cl. A01K 85/01

(52) U.S. Cl. 43/42.06

(57) ABSTRACT

An embodiment of the invention is a fish scent dispenser that may be attached to any variety of fishing lure or fishing device to dispense scent derived from a scent source contained therein. A scent source can be added to a cavity defined by a base portion a lid portion of the fish scent dispenser when the portions are in an open configuration. The scent source can then be secured when the portions are in a closed configuration. The scent contained in or created by the scent source is dispersed through vents in the lid portion when the fish scent dispenser is submerged.

### RELATED CASES

This case is related to “Fish Scent Dispensing Fishing Device” filed herewith.

### FIELD

Embodiments of the invention pertain to fishing lure equipment, and more particularly to a scent-dispensing attachment for a fishing lure or fishing device.

### BACKGROUND

“I shall stay him no longer than to wish him a rainy evening to read this following discourse; and that if he be an honest angler, the east wind may never blow when he goes a fishing.” Izaak Walton, The Complete Angler, Author's preface.

Recreational or sport fishing has been increasing in popularity. One of the most exciting and popular varieties of sport fishing involves so-called trolling type fishing, in which a number of lines and lures may be pulled behind and to the side of a fishing boat as the boat moves through the open ocean, river, or lake. The variety of lures available to sport fisherman is legendary. Some lures have been designed to attract fish by virtue of arresting and attractive color schemes. Other lures attract fish because, when the lures are drawn behind the boat, the lures undergo an oscillatory pitching or rolling motion. Still other lures are designed to dispense chum or scent meant to attract fish. The practice of chumming involves the dispensation of various fluids or small particulate matter having a particular odor attractive to the fish sought to be caught by the fishermen. If chum is spread in the water by a lure or near a lure, fish are more likely to be attracted and caught.

However, many fish scent dispensing devices are not optimized to increase fish scent dispersal. Water may not flow easily into and out of the dispenser. It is often difficult to replace the fish scent in the dispenser. Further, as fishing lure and device prices have increased with the popularity of the sport, it may be cost ineffective for a fisherman to replace or supplement his collection of lures and devices, some time-honored if not talismanic, with newer lures or devices designed to dispense scent.

### BRIEF DESCRIPTION OF THE DRAWINGS

The present invention will be understood more fully from the detailed description given below in conjunction with the accompanying illustrations of an embodiment or embodiments of the invention. The illustrations, however, should not be taken to limit the invention, but are for explanation and understanding only.

FIG. 1: illustration of a fish scent dispenser of an embodiment in a open configuration.

FIG. 2: illustration of a fish scent dispenser of an embodiment in an closed configuration.

FIG. 3: illustration of a fish scent dispenser of an embodiment attached to a dodger.

FIG. 4: illustration of a fish scent dispenser of an embodiment attached to a downrigger weight.

FIG. 5: illustration of a scent tablet.

FIG. 6: illustration of a fish scent dispenser of an embodiment attached to a diver.

FIG. 7: illustration of a fish scent dispenser of an embodiment attached to another diver.

FIG. 8: illustration of a fish scent dispenser of an embodiment attached to a flasher.

FIG. 9: illustration of a fish scent dispenser of an embodiment attached to a spinner.

FIG. 10: illustration of a fish scent dispenser of an embodiment attached to a fishing lure.

FIG. 11: illustration of a fish scent dispenser of an embodiment attached to a sliding weight holder.

FIG. 12: illustration of a fish scent dispenser of an embodiment attached to a bait holder.

It is noted that the drawings of embodiments are merely schematic representations and are not intended to portray specific parameters of the invention. The drawings are intended to depict only typical embodiments of the invention, and therefore should not be considered as limiting the scope of the invention.

### DETAILED DESCRIPTION

Embodiments of a fish scent dispenser will be described. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

Simply stated, an embodiment of the invention is a fish scent dispenser that may be attached to any variety of fishing lure or fishing device to dispense scent derived from a scent source contained therein. The fish scent dispenser may be formed by, among other elements, a base portion and a lid portion that are coupled together in a clamshell configuration. A scent source can be added to a cavity defined by the base portion and the lid portion when the portions are in an open configuration. The scent source can then be secured when the portions are in a closed configuration. The scent contained in or created by the scent source is dispersed through vents in the lid portion when the fish scent dispenser is submerged.

Further, as used herein, and by way of illustration only, the fish scent source material utilized in an embodiment may be in the form of either solidified or deformable fish attractant material or a liquid applied to a porous material, like a sponge material or hydrophilic foam, that is adapted to absorbedly receive commercially available fish attractant liquid, gel, or paste to be repeatedly impregnated therein.

Further, the description will refer to fishing lures and fishing devices. As used herein, and as understood in the art, fishing lures contain a hook or hooks to catch fish. Fishing devices do not contain hooks, but are used in conjunction with fishing lures to, for example, add attraction to or control the depth of the fishing lure.

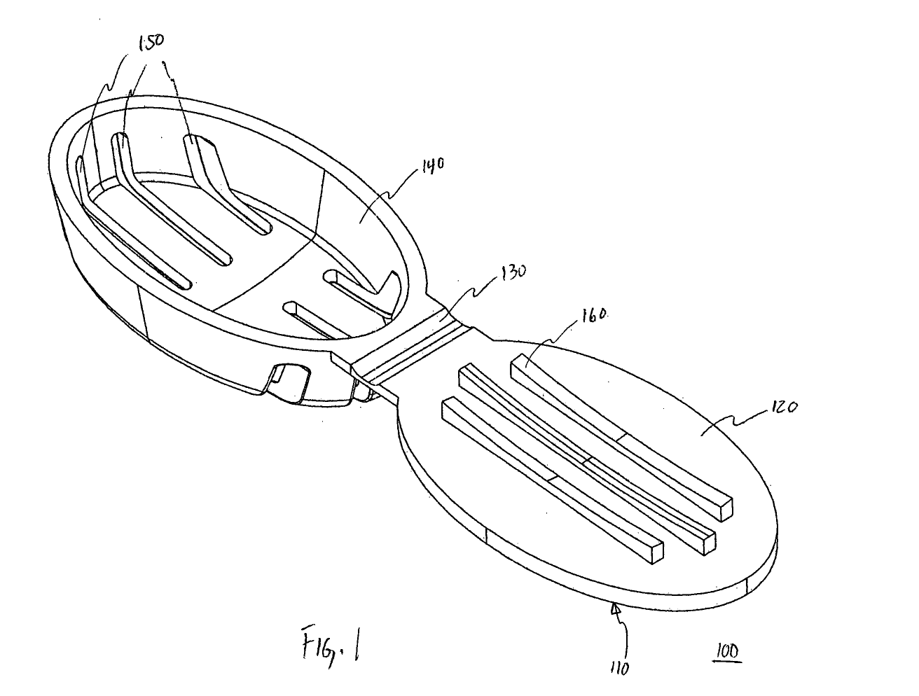

FIG. 1 illustrates an embodiment of a fish scent dispenser 100 in an open configuration. A base portion 120 is coupled to a lid portion 140 with a hinge 130. In an embodiment, an adhesive 110 may be coupled to the base to adhere or attach the fish scent dispenser 100 to any type of fishing lure or fishing device. The lid portion 140 further contains any number of vents 150 to expose a cavity defined by the base portion 120 and lid portion 140, and any contents therein, to water when the fish scent dispenser 100 is submerged. The base portion 120 may further include rails 160 to offset a scent source from the base portion's 120 surface to promote water flow to all sides of the scent source

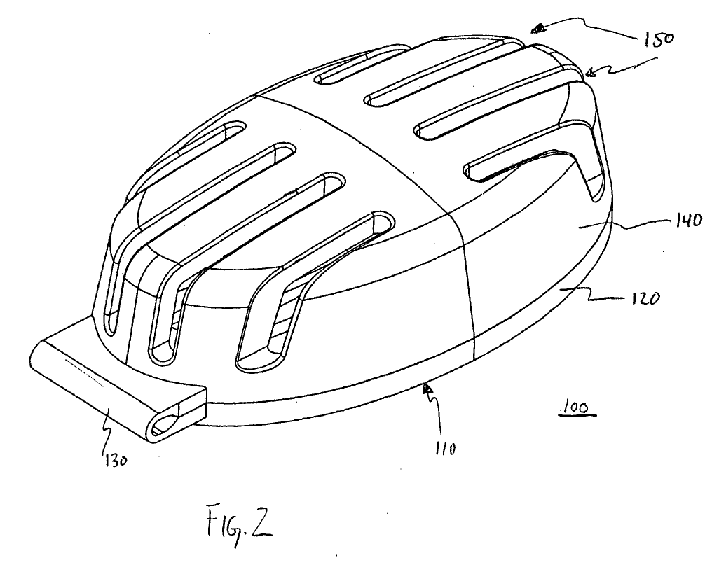

FIG. 2 illustrates an embodiment of a fish scent dispenser 100 in a closed configuration. In the closed configuration, the lid portion 140 and the base portion 120 detachably engage to define a cavity therein. The lid portion 140 and the base portion 120 may detachably engage in any manner known in the art that would enable the two portions to remain engaged when, for example, exposed to water currents common to fishing. The force required to disengage the lid portion 140 and the base portion 120 (e.g., alter the fish scent dispenser from the closed configuration to the open configuration) may be, however, consistent with operating the fish scent dispenser with, for example, a finger nail versus requiring a tool. In an embodiment, the lid portion 140 and base portion 120 are detachably engaged with a snap closure. The snap closure may be an annular snap, a cantilever snap, or any other type of snap closure.

The hinge 130 is illustrative of an element by which the lid portion 140 and the base portion 120 remain attached while the fish scent dispenser 100 is the open configuration. It is to be understood that any mechanism by which the two portions would be attached could be used. Further, the hinge 130 maybe omitted and the fish scent dispenser would comprise the lid portion 140 and the base portion 120 as separate components until detachably engaged to form the fish scent dispenser 100 with the cavity defined thereby.

The vents 150 facilitate water flowing across the scent source to disperse scent in the proximity of, for example, a fishing lure or fishing device. In general, a fishing lure or device is unidirectional. In other words, a fishing lure or device is connected, generally at one end, to the fishing line that is in turn, coupled to the fishing rod, fishing reel, and fisherman holding the rod and reel such that the fishing lure has a natural orientation as it is retrieved or trolled through the water. In an embodiment, the vents 150 include entrance openings and exit openings parallel to an axis of the fish scent dispenser 100. The fish scent dispenser 100, when attached to a fishing lure or device, may have the axis of the vents 150 substantially parallel to the lure's or device's natural orientation based on its direction of retrieve or troll. By this configuration, water more easily flows through the fish scent dispenser 100, both reducing drag of the lure or device to which the fish scent dispenser 100 is attached, and exposing more water to the scent source secured in the fish scent dispenser 100 cavity.

It is to be understood, however, that the vents 150 may be configured differently. For example, the vents 150 may be a single opening in lieu of entrance and exit openings. The vents 150 may also be alterable such that the amount of water flowing through the vents 150 can be controlled. For example, individual vent 150 openings may be partially or completely occluded to reduce the amount of water flowing through the vent 150 opening or openings. The alterable vents 150 would allow a fisherman to control the quantity of scent provided as well as tune the lifespan of the scent source.

The vents 150 may further be designed with hydrodynamically functional configurations. For example, the vents 150 may be designed to steer, swirl, disrupt, or otherwise control the flow of influent water to alter the efficiency with which the scent dispenser 100 delivers scent to the effluent water. The vents 150 may further be designed for a particular range of troll or retrieve speeds. For example, trolling for salmon occurs at a different speed than bottom fishing for sturgeon, catfish, or halibut. Each situation may require a different vent 150 configuration to effectively deliver an appropriate amount of scent.

The fish scent dispenser 100 may be manufactured in a variety of materials with a variety of processes. In an embodiment, the fish scent dispenser 100 is fabricated of a plastic material that is injection molded. For example, the fish scent dispenser 100 may be fabricated from injection molded polypropylene. Polypropylene has an approximately neutral buoyancy so as not to adversely affect the fishing device or fishing lure to which it is attached. Further, polypropylene is well suited for hinge 130, particularly when hinge 130 is configured as a living hinge. In another embodiment, the fish scent dispenser 100 is fabricated of a pliable material that can adjust to the contour of the fishing lure or fishing device to which it is attached.

The fish scent dispenser 100 material may further incorporate fish attracting color or color combinations, reflective material (e.g., glitter or metal flakes), glow-in-the-dark material, fluorescent material, ultraviolet-active material, and combinations thereof. The color and/or other attracting material may be applied to the surface of the fish scent dispenser 100 or it may be incorporated as an additive to the, for example, injection molded polypropylene.

As noted, the fish scent dispenser may be attached to any type of fishing lure or fishing device. As illustrated by FIGS. 1 and 2, the base portion 120 may have coupled thereto an adhesive 110. The adhesive 110 may be, for example, a foam backed adhesive tape. The adhesive may further be provided directly of the surface of the base portion 110. Any adhesive that is well known in the adhesive arts may be used provided that it is substantially water-resistant to maintain the adhesion between the fish scent dispenser 100 and the fishing lure or device to which the fish scent dispenser 100 is attached. In an embodiment, the fish scent dispenser 100 does not include an adhesive. The fisherman can then provide his choice of adhesive when installing the fish scent dispenser 100 on their fishing lures or devices.

In particular, a foam backed adhesive tape can be supplied with a variety of foam thickness options and foam shape configurations. This allows the fish scent dispenser 100 to be attached to a variety of fishing device or fishing lure surface geometries for which the deformability of the foam in the foam backed adhesive tape enables more adhesive surface to contact the fishing lure or fishing device.

The fish scent dispenser 100 may further be attached to a fishing lure or fishing device with an ultrasonic weld, a heat weld, or a combination thereof. In particular, a fish scent dispenser 100 fabricated with polypropylene as discussed above may be heat welded to a fishing lure or fishing device that has a similar plastic composition.

It is to be understood that the exact configuration of the base portion 120 of the fish scent dispenser 100 may depend on the adhesive or attachment mechanism desired. For example, to attach the fish scent dispenser 100 to a fishing device or fishing lure with an epoxy, the base portion 120 may be scored or otherwise textured to increase the surface area of the base portion 120 with which the epoxy can interact to secure the fish scent dispenser 100 to the fishing lure or fishing device. Further, the base portion 120 may include a single hole or multiple holes through which a fisherman can insert a screw, bolt, nail, or similar appliance to attach the fish scent dispenser 100 to a fishing lure or fishing device. The hole or holes may further be countersunk so that the attachment appliance does not substantially interfere with the fish scent dispenser 100 cavity.

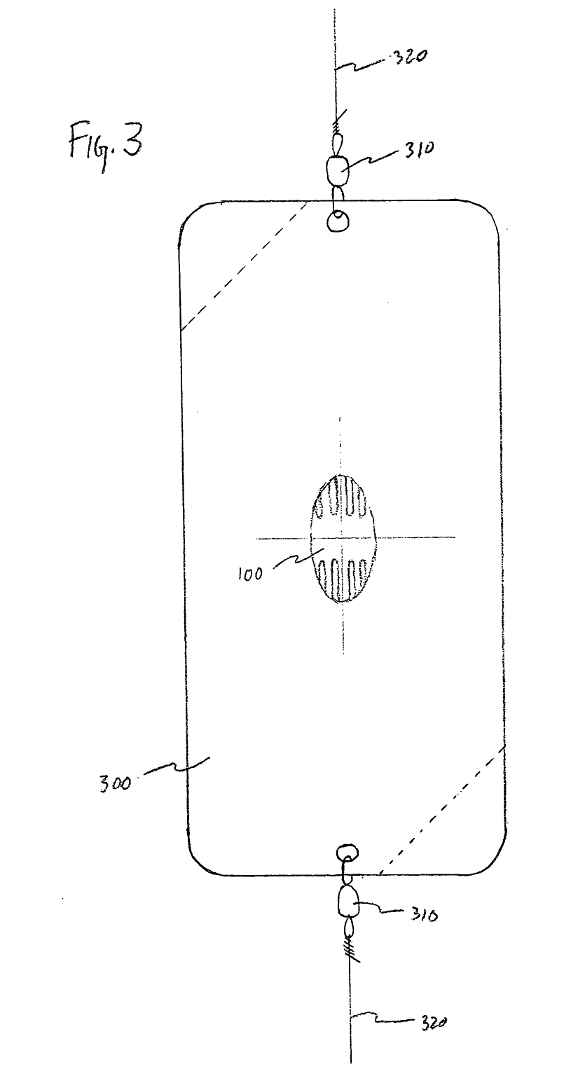

FIG. 3 illustrates the fish scent dispenser 100 coupled to a dodger 300. A dodger 300 is a fishing device inserted in a fisherman's line 320 adjacent to the fishing bait or lure containing the hook, and may include swivels 310. The dodger 300 is designed to spin or otherwise oscillate to attract fish. For example, the dodger 300 may include fish attracting color or color combinations, reflective material (e.g., glitter or metal flakes), glow-in-the-dark material, fluorescent material, and combinations thereof. The dodger 300 may also, by spinning, provide vibrations in the water that attract or otherwise stimulate fish through their lateral line sensitivity.

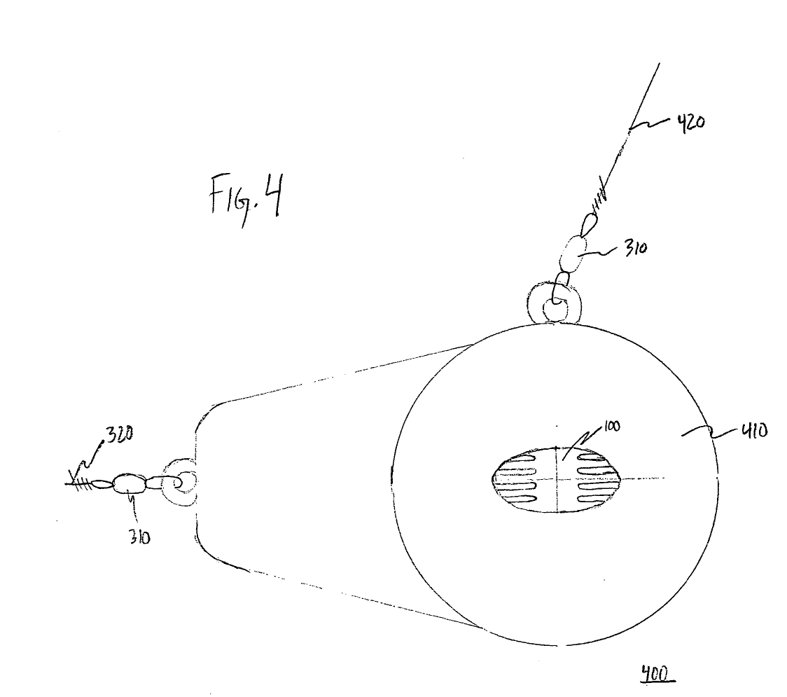

FIG. 4 illustrates the fish scent dispenser 100 coupled to a downrigger weight 400 including a weight portion 410. A downrigger weight 400 attaches to a main fishing line 420 to control depth of the fishing lure or device that is attached to fishing line 320. The fishing lines 320 and 420 may also attach to swivels 310. The fish scent dispenser 100 is attached to the downrigger weight 400 such that the direction of travel of the downrigger weight 400 though the water is parallel to the axis of the fish scent dispenser 100. The vents 150 are thereby aligned with the flow of the water to dispense scent.

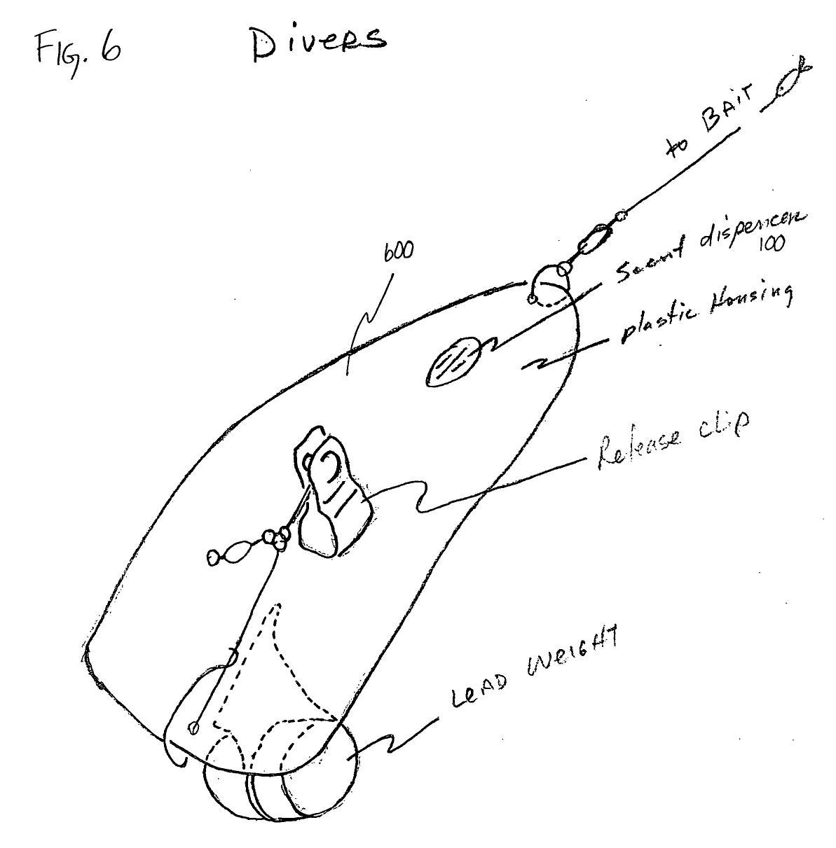

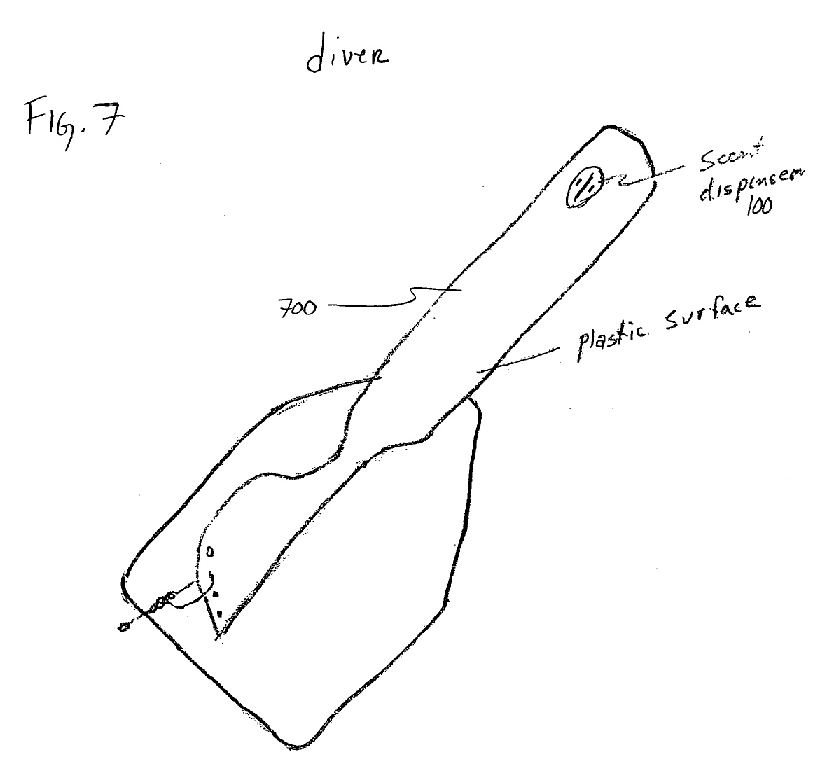

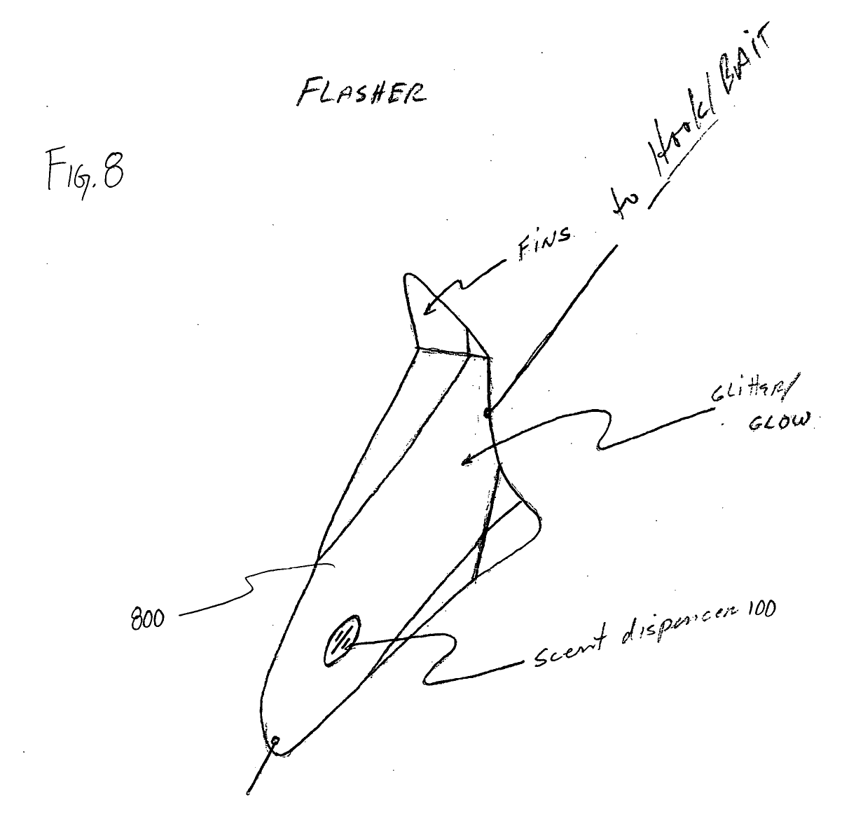

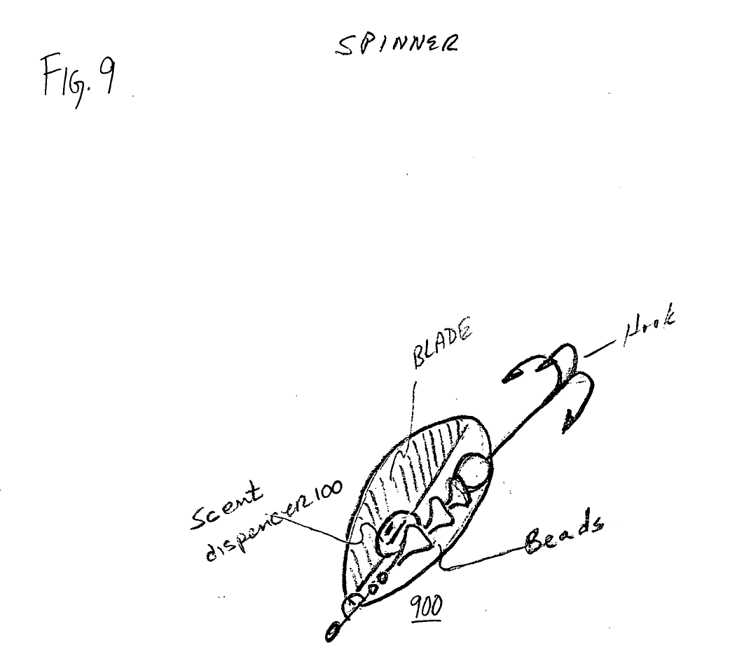

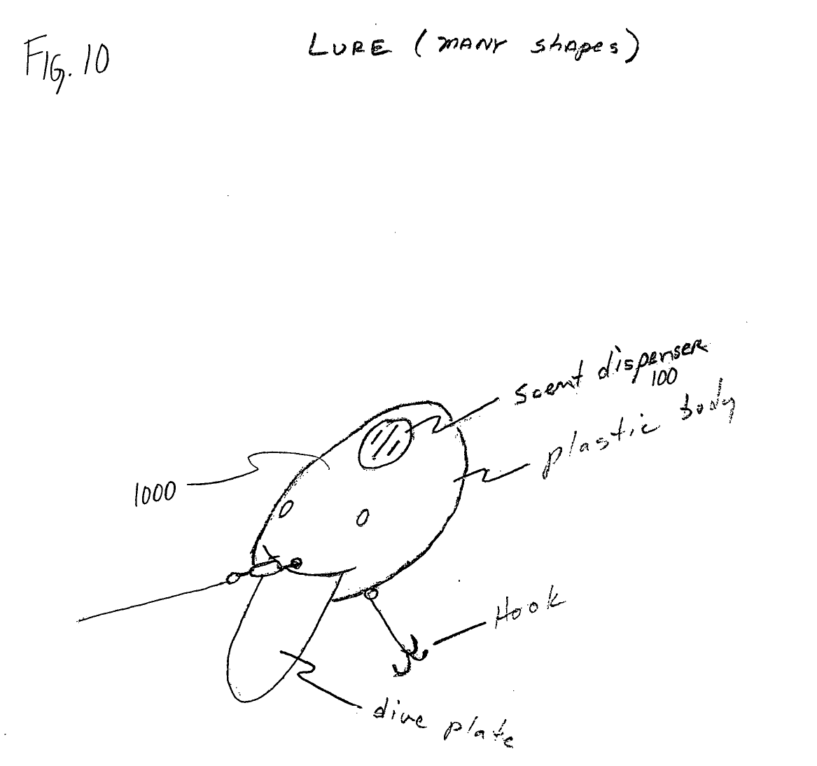

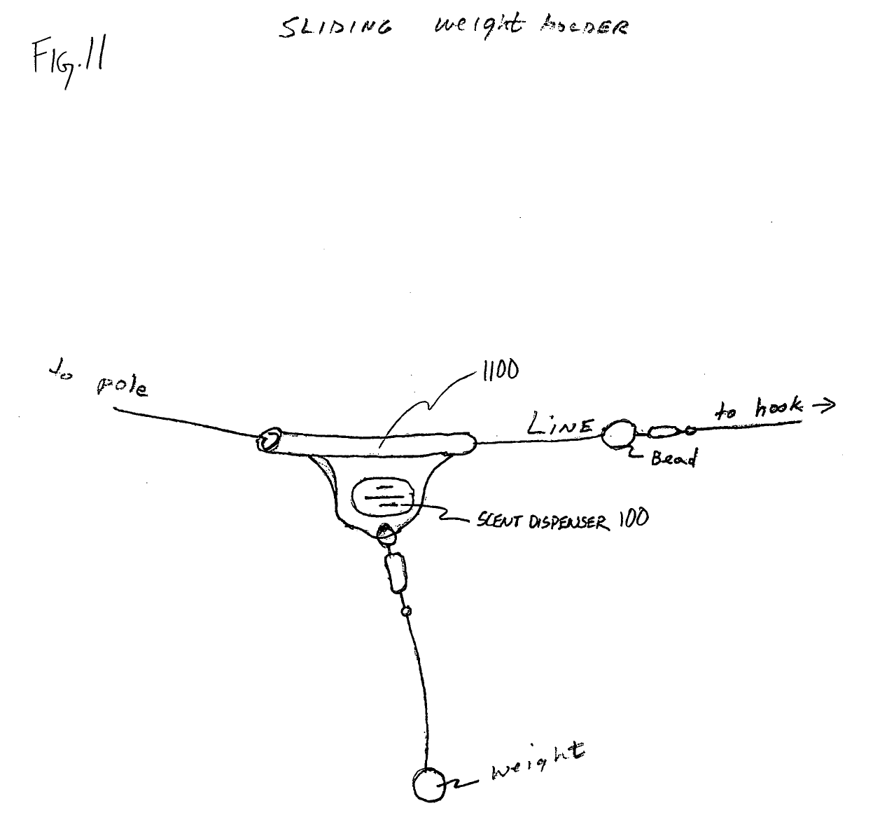

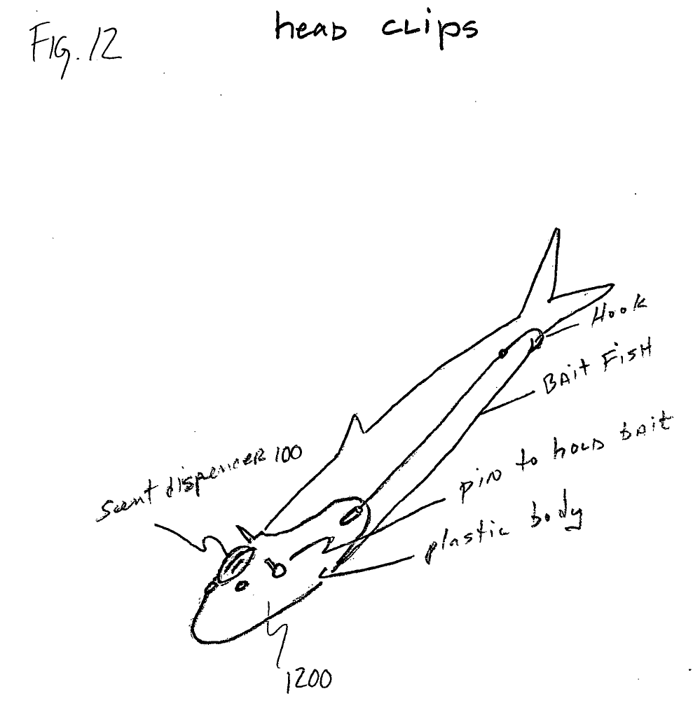

FIG. 6 through FIG. 12 illustrate additional fishing devices and fishing lures to which the fish scent dispenser 100 may be attached. FIG. 6 illustrates the fish scent dispenser 100 attached to a diver 600. FIG. 7 illustrates the fish scent dispenser 100 attached to another diver 700. FIG. 8 illustrates the fish scent dispenser 100 attached to a flasher 800. FIG. 9 illustrates the fish scent dispenser 100 attached to a spinner 900. FIG. 10 illustrates the fish scent dispenser 100 attached to a fishing lure 1000. FIG. 11 illustrates the fish scent dispenser 100 attached to a sliding weight holder 1100. FIG. 12 illustrates the fish scent dispenser 100 attached to a bait holder 1200. It is to be understood that while the fish scent dispensers 100 illustrated have an orientation and location with respect to the lures or devices to which they are attached, other orientations and locations are possible. Further, a single fishing lure or fishing device may have attached thereto multiple fish scent dispensers 100.

Though illustrated with reference to a variety of specific fishing devices and fishing lures, it is to be understood that the fish scent dispenser 100 can be attached to any fishing device or fishing lure from which it would be useful to provide scent. Additional devices include floaters, weights (i.e., sinkers), weight slides, flashers, spinners, divers, side planers, and trolling rudders. In particular, the fish scent dispenser 100 can be attached to the family of devices manufactured by LUHR JENSEN, including but not limited to the JET DIVER, the DIPSY DIVER, the PINK LADY, the HOT SHOT, the DEEP SIX, and the DOUBLE DEEP SIX. The fish scent dispenser may further be attached to the SLIDE DIVER manufactured by U-CHARTERS, INC.

As noted, the fish scent dispenser 100 may also be attached to a fishing lure as illustrated by fishing lure 1000 of FIG. 10. For example, the fish scent dispenser may be attached to a crankbait, an in-line spinner, a spinner bait, a topwater bait, a spoon, a jig, or any other form of artificial fishing bait. In particular, the fish scent dispenser can be attached to RAPALA crankbaits and topwater baits, LUHR JENSEN'S KWIKFISH and J-PLUG crankbaits, and WORDEN'S ORIGINAL FLATFISH crankbait. The fish scent dispenser 100 may further be attached to live or natural bait rigs or baitholders, as are known in the art, to enhance the scent produced by the live or natural bait.

The size of the fish scent dispenser 100 may also be altered depending on the size or intended use of the fishing lure or fishing device to which the fish scent dispenser 100 will be attached. For example, in a higher speed troll with a large flasher 800 or dodger 300, a larger fish scent dispenser 100 may be used to provide more cavity space for a scent source or multiple scent sources. Given the size of the flasher 800 or dodger 300, the fishing device performance (e.g., spinning, oscillating, or similar motion) may not be sufficiently altered by the attachment of a single or multiple fish scent dispensers 100. Alternatively, a smaller fish scent dispenser 100 may be more appropriate to attach to a fishing lure. For example, a smaller fish scent dispenser 100 is less likely to alter the performance of a, for example, crankbait for which the shape of the lure is highly important to determine its fish-attracting action as it is trolled or retrieved.

As noted, the cavity is accessible when the fish scent dispenser 100 is in the open configuration to apply, insert, or otherwise provide a scent source that is then contained within the fish scent dispenser 100 in a closed configuration. In an embodiment the scent source is a sponge material. The sponge material can be any type of material designed to absorb fish scent. In an alternate embodiment, the scent source is a hydrophilic foam. The fish scent, in the form of a liquid, gel, powder, or similar composition can be placed, squirted, squeezed, or otherwise provided to the sponge or hydrophilic foam material to disperse scent when the fish scent dispenser 100 is submerged. In an embodiment, there are multiple sponges or pieces of hydrophilic foam.

The scent source may further be a paste or solid pellet of fish attracting material that is placed, squirted, squeezed or deposited within the cavity of the fish scent dispenser 100. There are many types of these paste, moldable, or solid material concoctions currently on the market that may be placed in the cavity in such a manner. For example, the scent source may be BERKELY TROUT DIP, BERKELY SELECT GLITTER TROUT BAIT, BERKELY GLITTER TURBO DOUGH, CRAVE NITRO DOUGH, CRAVE NITRO PREMIUM, CRAVE NITRO GREASE, CRAVE GRAVY, TOP SECRET AMINOGEL, EXUDE ERUPT, or EXUDE MAGIC MORSELS.

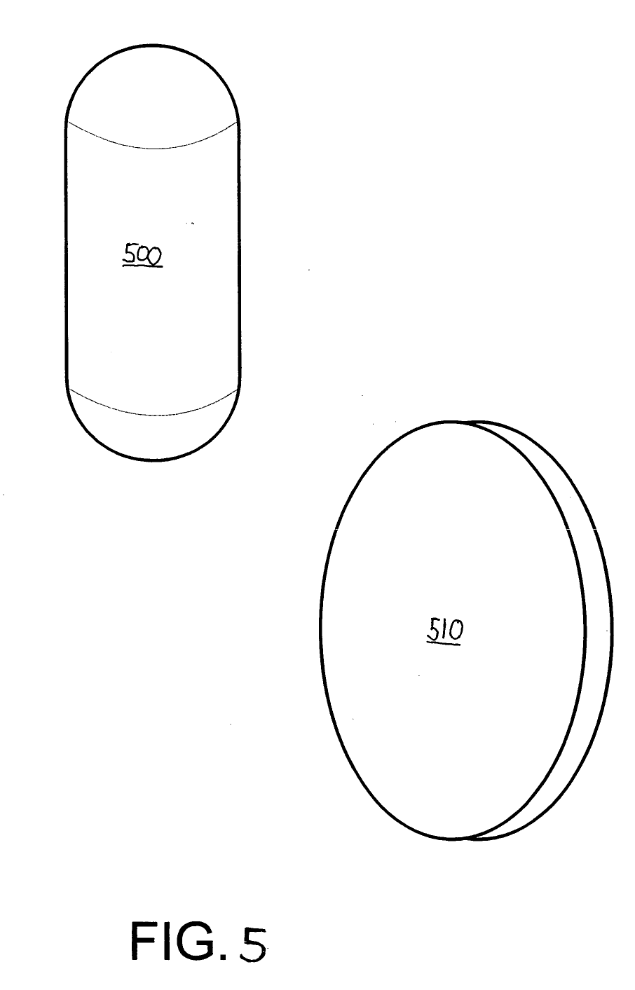

In addition to solid materials that may be used in place of a sponge, a scent-releasing tablet may be used in the cavity, such as a pill-shaped oblong tablet 500 and a round tablet 510 as illustrated in FIG. 5. In an embodiment, a water-soluble tablet made of a water-soluble material is used in the cavity. The water-soluble tablet dissolves gradually to release scent particles behind the fish scent dispenser 100 as the fish scent dispenser 100 moves through the water. The dissolution of the tablet can vary based on the properties of the tablet, for example, to provide for a slower release. This can be accomplished by, for example, varying the size of the tablet or by altering the composition of the base material of the tablet. The dissolution rate can further be altered by the pressure under which tablet is formed. It is also contemplated that additional tablets may be used to increase the dissolution time or to incorporate a fisherman's recipe of multiple scents

In further regards to FIG. 5, the tablets 500 and 510 may release various scents to attract fish. Specific scents may be more specially adapted for use with certain species of fish, for example. An illustrative, but non-exclusive list of possible scents includes: shrimp scent, sturgeon scent, sardine scent, salmon egg milk, anchovy, crawfish, anise, sand shrimp, corn scent, garlic, salmon with roe, earthworm scent, smelt scent, shad, herring, catfish cocktail, minnow scent, kokanee scent, kenai scent, halibut chum, and hatchery scent. As noted, placing multiple tablets of different scents in the same fish scent dispenser 100 may combine scents.

In addition to various scents, the tablets 500 and 510 may include various features of appearance that aid in attracting fish. For example, the tablets may be made of a material that is designed to be florescent, glow-in-the-dark, neon, or ultra-violet active. The tablet may further effervesce to create bubbles. Other colors, features, or combinations thereof may also be used.

In addition to the previously indicated variations, numerous other modifications and alternative arrangements may be devised by those skilled in the art without departing from the spirit and scope of the present invention and the appended claims are intended to cover such modifications and arrangements. Thus, while the present invention has been described above with particularity and detail in connection with an embodiment or embodiments of the invention, it will be apparent to those of ordinary skill in the art that numerous modifications, including, but not limited to, variations in size, materials, shape, form, function, manner of operation, assembly, and use may be made without departing from the principles and concepts set forth herein.

One skilled in the art will recognize the elegance of the disclosed embodiment in that it improves the ability with which fishermen can attract fish to their fishing lures.

1. A fish scent dispenser comprising:
a base portion;
a lid portion coupled to the base portion wherein the lid portion includes a plurality of vents, each vent including an entrance opening not flush with a surface of the base portion and an exit opening not flush with the surface of the base portion when the base portion and the lid portion are configured in a closed position;
wherein the base portion and the lid portion define a cavity to secure a scent source when configured in the closed position.

2. The fish scent dispenser of claim 1 wherein the cavity is accessible to a user when the base portion and the lid portion are configured in an open position.

3. (canceled)

4. (canceled)

5. The fish scent dispenser of claim 1 wherein the lid portion is coupled to the base portion with a living hinge.

6. The fish scent dispenser of claim 1, the scent source to dispense scent through the vents when the fish scent dispenser is submerged.

7. The fish scent dispenser of claim 6 wherein the scent source is located in the cavity when the base portion and lid portion are in the open position.

8. The fish scent dispenser of claim 6 wherein the scent source is secured in the cavity when the base portion and lid portion are in the closed position.

9. The fish scent dispenser of claim 1 wherein the scent source comprises a scent tablet.

10. The fish scent dispenser of claim 1 wherein the scent source comprises a sponge.

11. The fish scent dispenser of claim 1 wherein the scent source comprises a hydrophilic foam.

12. The fish scent dispenser of claim 1 further comprising an adhesive coupled to the base portion on the side of the base portion opposite the lid portion.

13. The fish scent dispenser of claim 12 wherein the adhesive comprises a foam-backed adhesive tape that is substantially water-resistant.

14. The fish scent dispenser of claim 12 wherein the adhesive is configured to adhere to a fishing device selected from the group consisting of a diver, a dodger, a flasher, a spinner, a downrigger weight, a sinker, a floater, a spoon, a trolling rudder, a side planer, a bait holder, and a weight slide.

15. The fish scent dispenser of claim 12 wherein the adhesive is configured to adhere to a fishing lure selected from the group consisting of a crankbait, an in-line spinner, a spinner bait, a topwater bait, a spoon, and a jig.

16. The fish scent dispenser of claim 1 wherein the lid portion and the base portion further comprise polypropylene.

17. The fish scent dispenser of claim 1 wherein the lid portion further comprises one or more of glitter, metal flakes, glow-in-the-dark material, fluorescent material, ultraviolet-active material, and a combination thereof.

18. A fish scent dispenser comprising:
a base portion;
a lid portion coupled to the base portion with a living hinge wherein the lid portion includes a plurality of vents and wherein the base portion and the lid portion define a cavity when configured in a closed position, each vent including an entrance opening not flush with a surface of the base portion and an exit opening not flush with the surface of the base portion when the base portion and the lid portion are in the closed position;
means for attaching the base portion to a fishing lure or fishing device; and
a scent source located in the cavity to dispense scent through the vents when the fish scent dispenser is submerged.

19. The fish scent dispenser of claim 18 wherein the cavity is accessible to a user when the base portion and the lid portion are configured in an open position.

20. (canceled)

21. (canceled)

22. The fish scent dispenser of claim 18 wherein the scent source comprises a scent tablet.

23. The fish scent dispenser of claim 18 wherein the scent source comprises a sponge.

24. The fish scent dispenser of claim 18 wherein the scent source comprises a hydrophilic foam.

25. The fish scent dispenser of claim 18, the attaching means configured to attach to a fishing device selected from the group consisting of a diver, a dodger, a flasher, a spinner, a downrigger weight, a sinker, a floater, a spoon, a trolling rudder, a side planer, a bait holder, and a weight slide.

26. The fish scent dispenser of claim 18, the attaching means configured to attach to a fishing lure selected from the group consisting of a crankbait, an in-line spinner, a spinner bait, a topwater bait, a spoon, and a jig.

27. The fish scent dispenser of claim 18 wherein the lid portion and the base portion comprise polypropylene.

28. The fish scent dispenser of claim 18 wherein the lid portion further comprises one or more of glitter, metal flakes, glow-in-the-dark material, fluorescent material, ultraviolet-active material, and a combination thereof.
